(19) United States
(12) Patent Application Publication
(10) Pub. No.: US 2019/0147431 A1
(43) Pub. Date: May 16, 2019

(54) Credit Protocol

(71) Applicant: BlockMason Inc., Belize City (BZ)

(72) Inventors: Timothy S. Galebach, Park City, UT (US); Jared Bowie, Las Vegas, NV (US); Michael Chin, Bellevue, WA (US); Luke Zhang, Bangkok (TH); Stephen H. Galebach, Medford, MA (US)

(21) Appl. No.: 15/815,448

(22) Filed: Nov. 16, 2017

(51) Int. Cl. G06Q 20/24; G06Q 20/40; G06F 21/60

(52) U.S. Cl. CPC G06Q 20/24; G06Q 2220/00; G06F 21/602; G06Q 20/40

(57) ABSTRACT

Embodiments employ the blockchain to democratize the creation of debt and credit in a digital environment. The embodiments are directed to systems and methods for executing debt and credit transactions in the digital environment. The systems and methods register a first user and second user with a credit protocol application, including providing a respective first and second user identifier recorded in the blockchain. The systems and methods establish a relationship, via the credit protocol application, between a first computing device of the first user and a second computing device of the second user by validating: (i) the first identifier includes an address of the first computing device, and (ii) the second identifier includes an address of the second computing device. Based on the established relationship, the systems and methods send from the first computing device a request for the transaction. The systems and methods, by the second user at the second computing device, receive and confirm the request. The systems and methods record the confirmed transaction in the blockchain associated to the first and second identifiers.

### BACKGROUND

The advent of decentralized transaction systems, such as Bitcoin, Ethereum Blockchain, and SmartContracts, has provided the Internet with a reliably secure protocol for recording ownership over digital value known as the blockchain. The blockchain is rooted in private keys and signatures that enable users to digitally preserve immutable historical records (blocks) of transactions in a common ledger linked and secured by cryptology. The common ledger structure of the blockchain makes it easy to write and read the records, and to verify their accuracy, and difficult for a malicious actor to alter the content or order of the records. The blockchain is built on the backs of thousands of peered servers and devised to be mathematically impenetrable. As long as a majority of participating peers act in support of the community, one cannot leverage enough computing power to edit records of the past and thus steal value.

Presently it is only possible to move money on the blockchain in the form of cash. For example, Bitcoin democratized the transfer and storage of money, and the Eutherum Blockchain democratized the creation and storage of monetary contracts.

### SUMMARY

Embodiments of the present invention provide a next step in the decentralized economy by democratizing the creation of debt and credit in a digital environment. Debt and credit are extremely powerful financial tools, which these embodiments strengthen by employing the security and flexibility of the blockchain. The embodiments are directed to credit protocol applications that execute, validate, and record debt and credit transactions with bilateral confirmation in the digital environment of a blockchain network. The embodiments establish relationships between the computing devices of users of the credit protocol applications to provide a secure and trusted digital environment for executing debt and credit transactions.

Embodiments of the present invention are directed to computer methods, systems, and program products for executing debt and credit transactions. The computer program products comprise a non-transitory computer-readable storage medium having code instructions stored thereon, the storage medium operatively coupled to a processor to execute the computer method embodiments. The computer systems comprise a first computing device coupled to a first user and having a first address, and a second computing device coupled to a second user and having a second address. The computer systems also comprise a credit protocol processor implementing the credit protocol application, and the credit protocol processor operating system (OS) communicatively coupled to the blockchain.

The computer methods, systems, and program products register the first user with a credit protocol application communicatively coupled to the blockchain. The registering of the first user includes providing a first user identifier recorded in the blockchain. The computer methods, systems, and program products further register the second user with the credit protocol application. The registering of the second user includes providing a second user identifier recorded in the blockchain. In some embodiments, each user is an entity, person, or system, and each user identifier is a text identifier associated with one or more public keys recorded in the blockchain for the respective user.

In some embodiments, the computer methods, systems, and program products register the users with the credit protocol application by enabling each user to sign a transaction indicating ownership of the respective user identifier. The user identifier comprises a public key of a key pair, and the user signs the transaction using a private key of the key pair. In some embodiments, the computer methods, systems, and program products register each of the users by attesting, via an identification validator coupled to the credit protocol application, the identity of the user. The attested identity of the user may include at least one of: date of birth of the user, photo identification of the user, voice identification of the user, current assets of the user, and credit history of the user. The computer methods, systems, and program products may attest to the identity of the user by performing, via the credit protocol application, biometric validation on the user. If the biometric validation confirms the identity of the user, the computer methods, systems, and program products record in the blockchain, by the identification validator, the user identity associated to the recorded first user identifier.

In some embodiments, the computer methods, systems, and program products may further attest to the identity of the user by the identification validator determining whether user identification presented by the first user matches physical characteristics of the first user. If the presented identification and the physical characteristics match, the computer methods, systems, and program products may enable the first user to sign a transaction indicating ownership of the first user identifier. The user identifier comprises a public key of a key pair, and the first user signs the transaction using a private key of the key pair. The computer methods, systems, and program products further record in the blockchain, by the identification validator, the user identification associated to the first user identifier.

In some embodiments, the computer methods, systems, and program products register a user by determining that the provided user identifier of the user is a single, unique identifier associated exclusively to the user for use in the credit protocol application. In some embodiments, the computer methods, systems, and program products record the user identifier in the blockchain permanently associated to the identity of the user. In some embodiments, the computer methods, systems, and program products provide a credit scoring application that, based on the user identifier, enables creditors to prove a debtor associated to the generated user identifier does not have undisclosed credit or debt and to compare complete financial resources of the debtor.

The computer methods, systems, and program products establish, via the credit protocol application, a relationship between a first computing device of the first registered user and a second computing device of the second registered user. The computer methods, systems, and program products establish the relationship by validating that: (i) the provided first user identifier includes an address of the first computing device, and (ii) the provided second user identifier includes an address of the second computing device. In some embodiments, the computer methods, systems, and program products establish the relationship by generating the first user identifier by relating addresses of different computing devices of the first user; each address associated with a public key recorded in the blockchain for the first user. The computer methods, systems, and program products establish the relationship by further generating the second user identifier by relating addresses of different computing devices of the second user; each address associated with a public key recorded in the blockchain for the second user. The computer methods, systems, and program products establish the relationship between the second computing device of the second user and the first computing device of the first user by validating that: (i) the address of the first computing device is one of the related addresses of the generated first user identifier, and (ii) the address of the second computing device is one of the related addresses of the generated second user identifier.

Based on the established relationship, the computer methods, systems, and program products send, by the first user from the first computing device to the second user at the second computing device, a request for a debt or credit transaction. The computer methods, systems, and program products receive, by the second user at the second computing device, the request, and confirm, by the second user at the second computing device, the debt or credit transaction. The computer methods, systems, and program products record the confirmed debt or credit transaction in the blockchain associated to the first and second user identifiers. In some embodiments, the computer methods, systems, and program products record, via the credit protocol application, the debt or credit transaction in the blockchain encrypted, and the credit protocol application is configured to decrypt the debt or credit transactions for processing.

In some embodiments, the computer methods, systems, and program products further configure parameters to validate debt and credit transactions. The computer methods, systems, and program products in these embodiments compare, by the credit protocol application, the validation parameters to data related to (i) the debt or credit transaction and (ii) the first and second user identifiers. The computer methods, systems, and program products in these embodiments record the debt or credit transaction only if the related data meet the validation parameters. In some of these embodiments, the validation parameters are defined by one or more smart contracts coupled to the credit protocol application, and the credit protocol application executes the one or more smart contracts to compare the validation parameters to the data related to the debt or credit transaction. In some of these embodiments, the validation parameters used to validate the debt or credit transaction include at least one of: debt or credit type, debt or credit amount, date of transaction, time of transaction, user identifier, relationship between users, currency of transaction, and frequency of transactions by a user or between users.

In some of these embodiments, the computer methods, systems, and program products acquire, by the first user identifier, at least one token from a smart contract coupled to the credit protocol application. Each token enables the first user identifier to participate in a given number of debt and credit transactions within a given period of time. The computer methods, systems, and program products then validate, by the credit protocol application executing the smart contract, possession of the acquired at least one token prior to enabling the first user to send the debt or credit transaction.

In some embodiments, the computer methods, systems, and program products further send, by the second user from the second computing device to the first user at the first computing device, a verification of at least one payment transaction associated to the confirmed debt or credit transaction. The computer methods, systems, and program products then receive, by the first user at the first computing device, the verification, and confirm, by the first user at the first computing device, the at least one payment transaction. The computer methods, systems, and program products record the confirmed at least one payment transaction in the blockchain associated to the debt or credit transaction.

In some embodiments, the computer methods, systems, and program products use a user identifier to provide a merchant points application that accrues and records user credit points from transactions by the respective user with one or multiple merchants. In some embodiments, the computer methods, systems, and program products compute a trust score of debt or credit transactions based on factors used in validating the debt or credit transaction.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1A is a digital processing environment in which embodiments of the present invention may be implemented.

FIG. 1B is a block diagram of an internal structure of a computer/computing node in the embodiment of FIG. 1A.

FIG. 2 is a block diagram of a distributed blockchain ledger system in example embodiments of the present invention.

FIG. 3 is a block diagram of a credit protocol system for executing, validating, and recording transactions in example embodiments of the present invention.

FIG. 4 is a flowchart of a credit protocol method of executing, validating, and recording transactions in example embodiments of the present invention.

FIG. 5A is a block diagram of network communication for generating master unitary user identifiers in example embodiments of the present invention.

FIG. 5B is a block diagram of a system for establishing relationships between computing devices (nodes) in a network in example embodiments of the present invention.

FIG. 5C is a flowchart of a method of establishing relationships between computing devices (nodes) in a network in example embodiments of the present invention.

FIG. 6A is a block diagram of a method of verifying a user identifier of the credit protocol application in example embodiments of the present invention.

FIG. 6B is a flowchart of a method of verifying and recording user identification in example embodiments of the present invention.

FIG. 6C is a block diagram of a system for verifying and recording user identification in example embodiments of the present invention.

FIG. 7 is an example trust score calculator that computes a trust score of debt and credit transactions in example embodiments of the present invention.

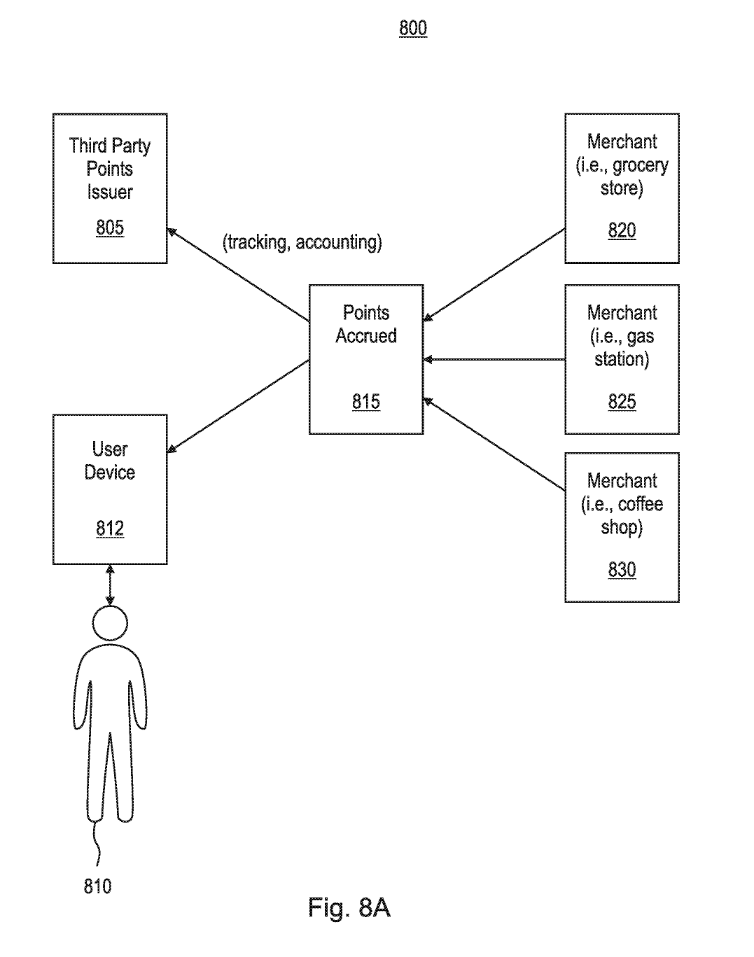

FIGS. 8A-8B are block diagrams of methods of accruing and recording credit points for user transactions in example embodiments of the present invention.

### DETAILED DESCRIPTION

A description of example embodiments follows.

Embodiments of the present invention provide computer methods, systems, and program products that facilitate validating, bilaterally confirming, recording, and tracking debt and credit transactions between users in a decentralized, distributed ledger system (e.g., blockchain). The embodiments also enable generation of master unified user identifiers (unique text-defined identifiers) that comprise multiple computing device (node) addresses associated with respective blockchain public keys of public-private cryptological key pairs. The unified user identifiers are used to establish relationships/edges between user computing devices (nodes) used to execute debt and credit transactions and/or blockchain nodes executing decentralized applications in the blockchain network. Embodiments are further disclosed in “The Credit Protocol Whitepaper,” version 1.01, by the Blockmason Team, dated Aug. 15, 2017, herein incorporated by reference in its entirety.

### Digital Processing Environment

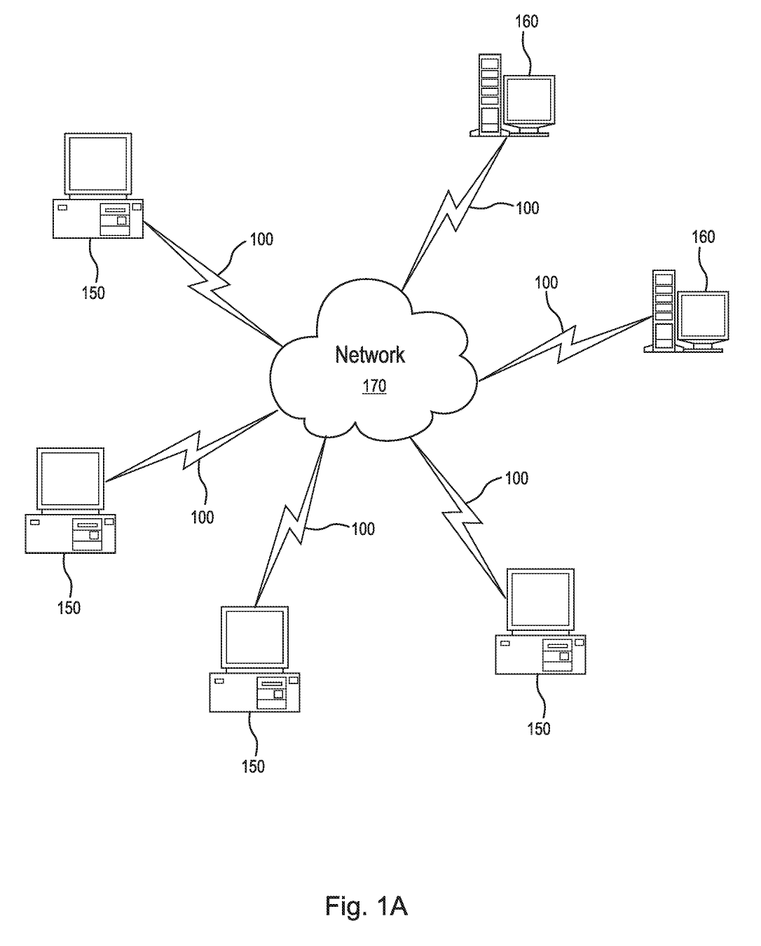

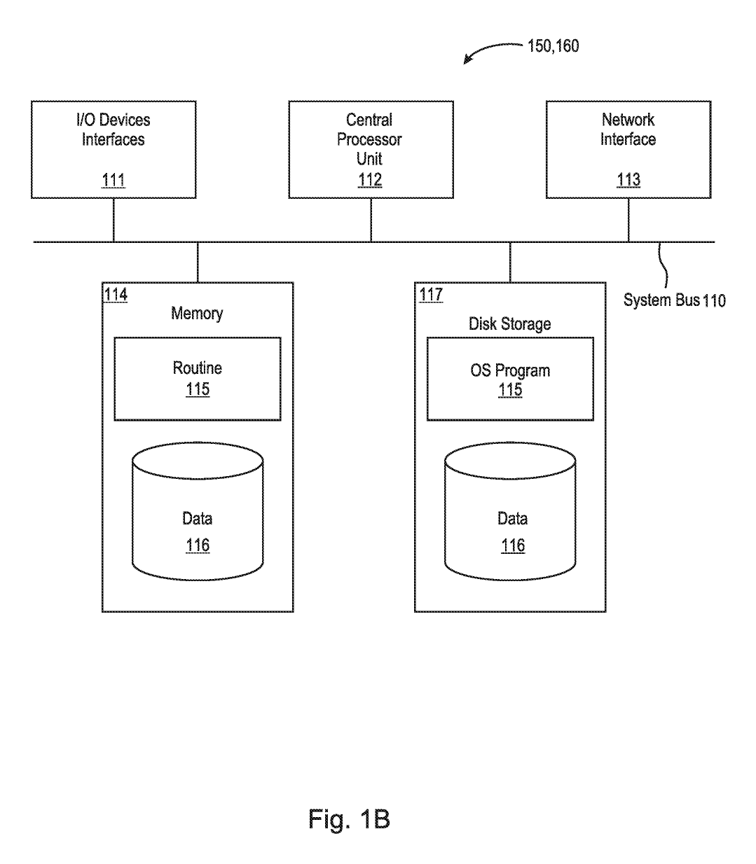

An example implementation of a credit protocol system 100 according to the invention for executing and recording debt and credit transactions may be implemented in a software, firmware, or hardware environment. FIG. 1A illustrates one such example digital processing environment in which embodiments of the present invention may be implemented. Client computers/devices 150 and server computers/devices 160 provide processing, storage, and input/output devices executing application programs and the like.

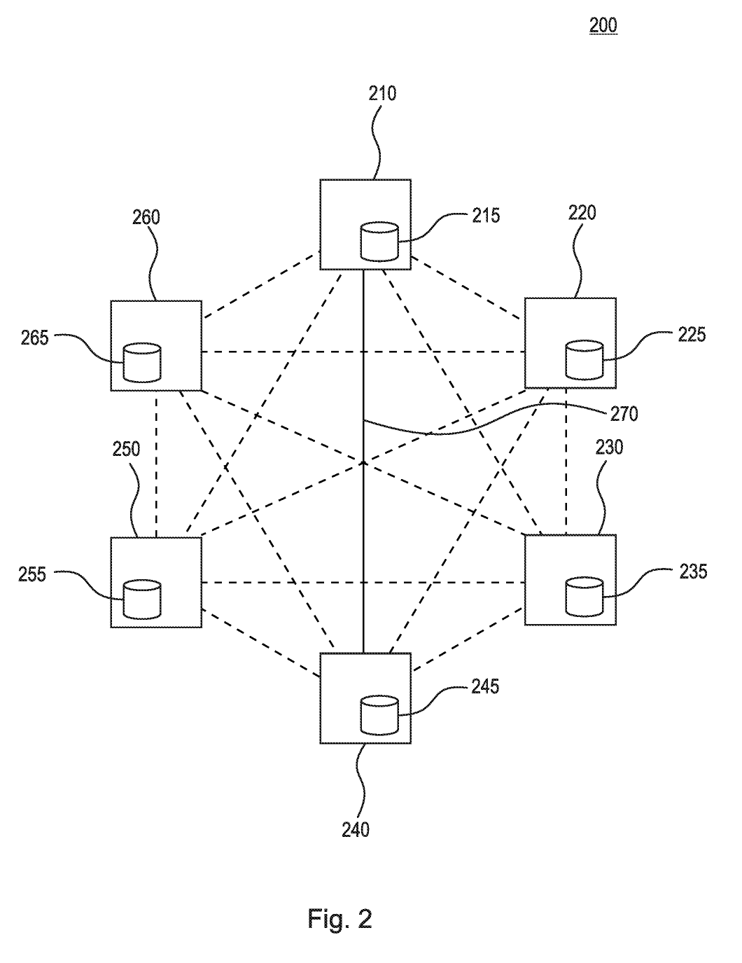

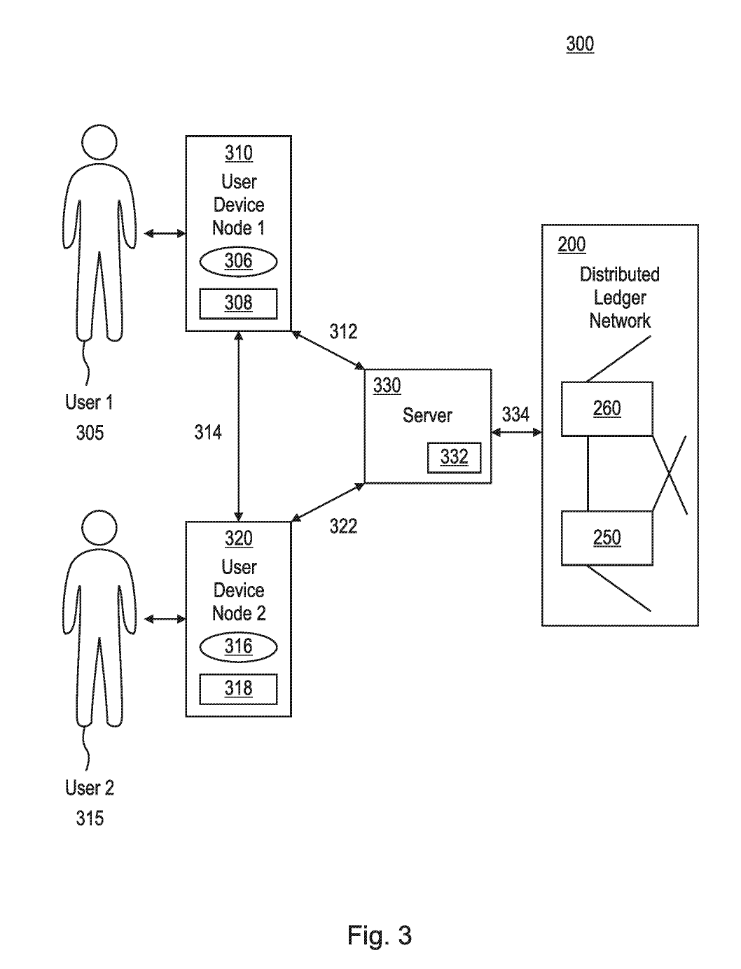

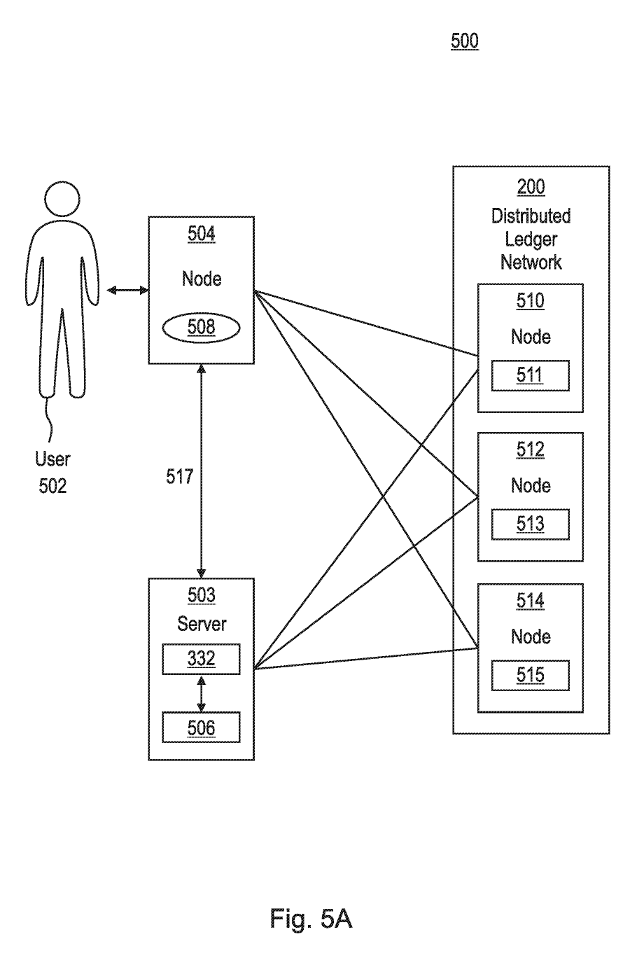

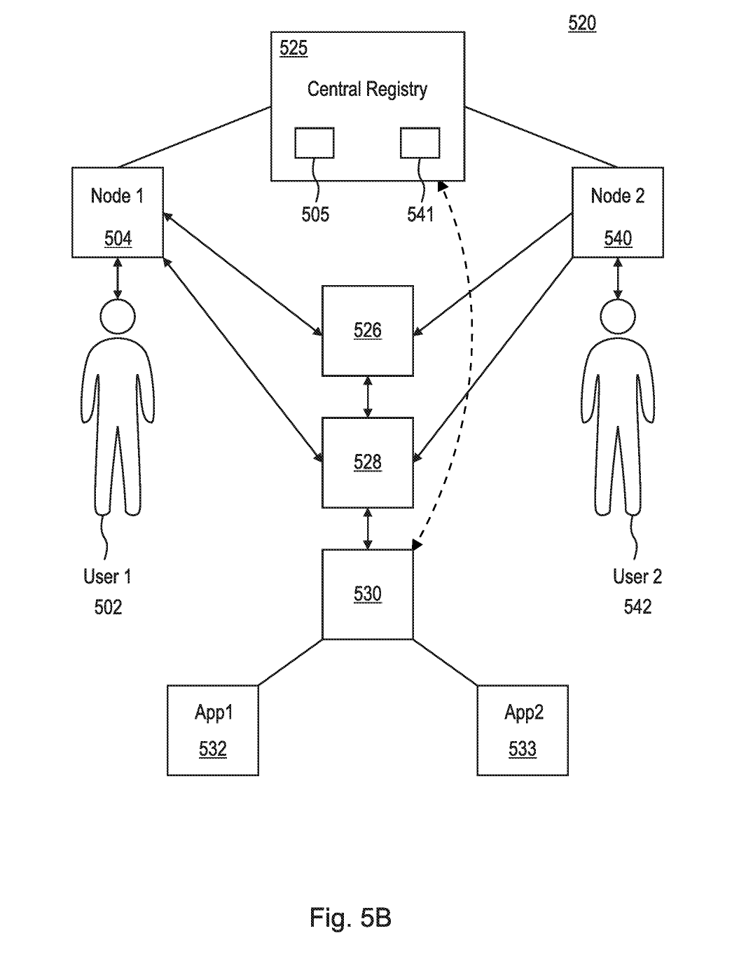

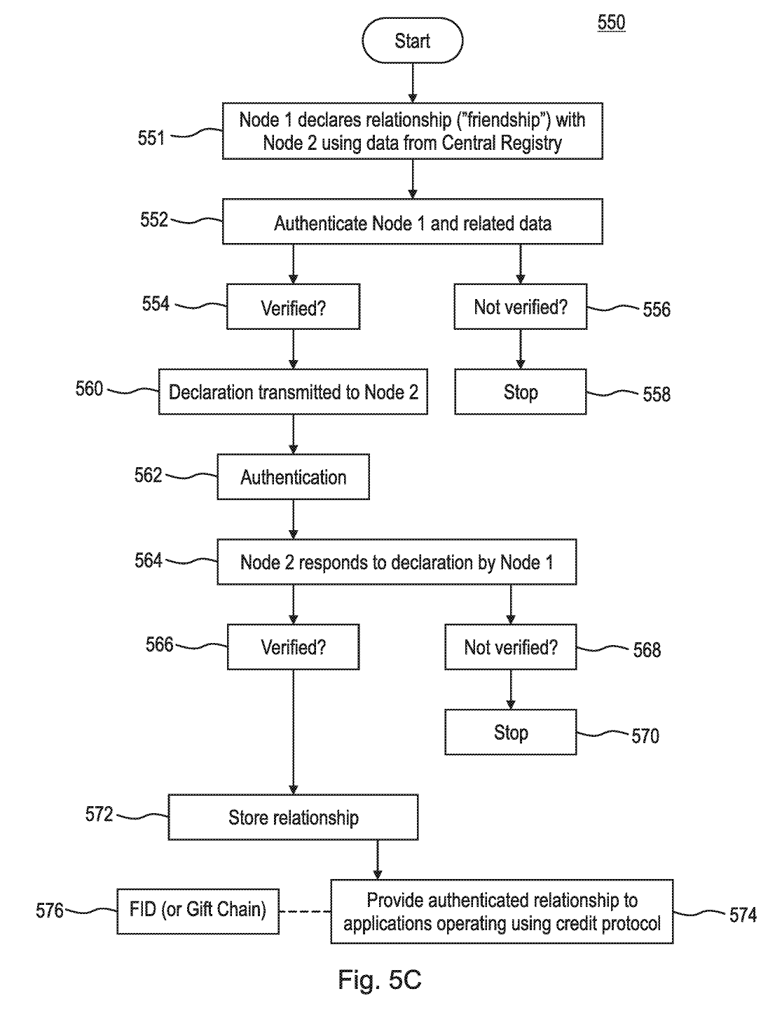

Client computers/devices 150 are linked through communications network 170 to other computing devices, including other client computers/devices 150 and server computer(s) 160. The network 170 can be part of a remote access network, a global network (e.g., the Internet), a worldwide collection of computers, Local area or Wide area networks, and gateways that currently use respective protocols (TCP/IP, Bluetooth, etc.) to communicate with one another. Other electronic device/computer network architectures are suitable. For example, client computers/devices 150 may include user devices 310, 320 shown in FIG. 3 and user devices 504, 540 shown in FIGS. 5A-5B, which execute user applications that enable a user to communicate with credit protocol and foundation applications to transmit, confirm, validate, and record transactions. For another example, client computers/devices 150 may include peer computing devices (nodes) 210, 220, 230, 240, 250, 260 of a distributed blockchain ledger 200 of FIG. 2 that records and maintains transaction records.

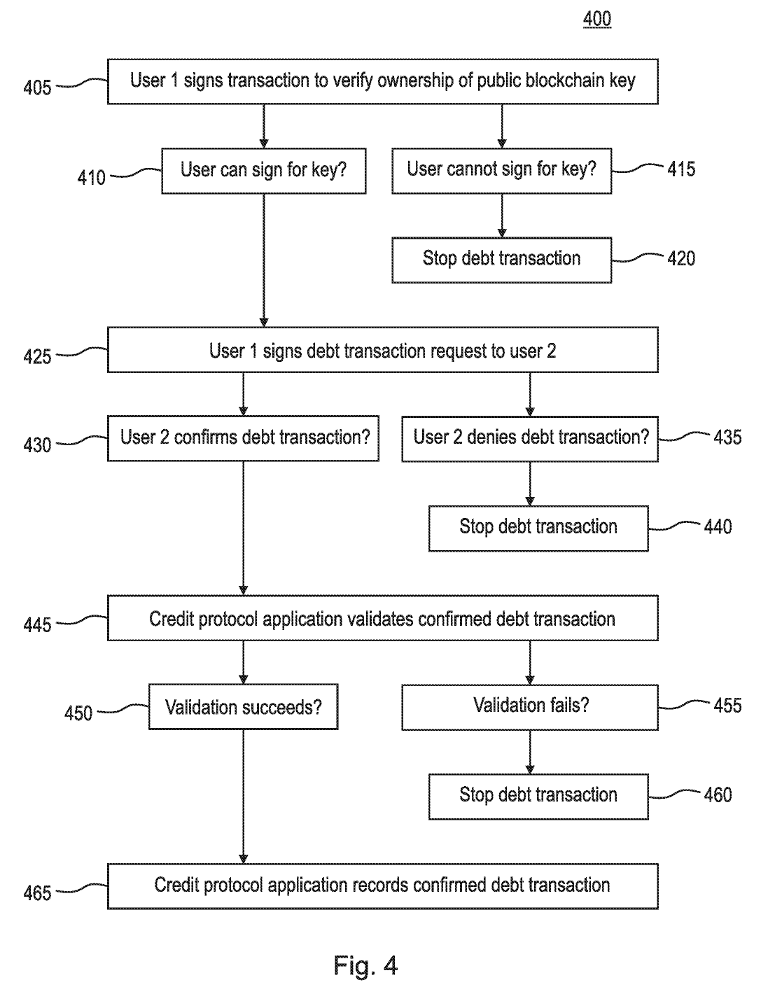

Server computers 160 of the credit protocol system 100 may be configured to include the server 330 of FIG. 3 that executes a credit protocol application 332, which verifies user ownership of a user identifier, validates debt and credit transaction requests and confirmations between users, and records confirmed debt and credit transactions (as shown in the method 400 of FIG. 4). Server computers 160 may be configured to further include a server 503 of FIG. 5A, which executes a foundation application, along with the credit protocol application, to generate a unified user identifier (unique text-defined identifier) that comprises multiple blockchain addresses; each address associated with a blockchain public key of a public-private cryptological key pair. Server computers 160 may be configured to further include a central registry 525 of FIG. 5B, which stores the generated unified user identifiers. The unified user identifier is used to declare, authenticate, and establish relationships (“friendships”) or edges between computing devices (nodes) of users that are used to validate debt and credit transactions between the users (as shown in network 520 of FIG. 5B that executes method 550 of FIG. 5C) or nodes of a blockchain ledger for executing decentralized apps.

FIG. 1B is a block diagram of any internal structure of a computer/computing node (e.g., client processor/device/mobile phone device/tablet/video camera 150 or server computers 160) in the processing environment of FIG. 1A, which may be used to facilitate displaying audio (e.g., voice identification), image (e.g., photo identification), video or data signal information. Embodiments of the invention may include means for displaying audio, image, video or data signal information. Each computer 150, 160 in FIG. 1B contains a system bus 110, where a bus is a set of actual or virtual hardware lines used for data transfer among the components of a computer or processing system. Bus 110 is essentially a shared conduit that connects different elements of a computer system (e.g., processor, disk storage, memory, input/output ports, etc.) that enables the transfer of data between the elements.

Attached to system bus 110 is I/O device interface 111 for connecting various input and output devices (e.g., keyboard, mouse, touch screen interface, displays, printers, speakers, audio inputs and outputs, video inputs and outputs, microphone jacks, etc.) to the computer 150, 160. Network interface 113 allows the computer to connect to various other devices attached to a network (for example the network illustrated at 170 of FIG. 1A). Memory 114 provides volatile storage for computer software instructions 115 and data 116 used to implement software implementations of components of the present inventions (e.g. credit protocol system 300 of FIGS. 3 and 5A).

Software components 114, 115 of the credit protocol system 100 described herein may be configured using any known programming language, including any high-level, object-oriented programming language. The system 100 may include instances of processes that enable verifying the user identifiers for users of debt and credit transactions, transmitting debt and credit transactions, confirming debt and credit transactions, validating confirmed debt and credit transactions (e.g., via smart contracts), and recording confirmed debt and credit transaction. The system 100 may include instances of processes that enable users to generate unified user identifiers associating node addresses to blockchain public keys. The credit protocol system 100 may also include instances of a trust scoring engine, which can be implemented as a client that communicates to the server 160 through SSL and computes a trust score that provides a measure of confidence that a transaction is trusted based on, for example, relationship of the user involved in the transaction, the amount of the transaction, the currency of the transaction, the date/time of the transaction, and such.

In an example mobile implementation, a mobile agent implementation of the invention may be provided. A client-server environment can be used to enable mobile credit protocol services using a credit network server. It can use, for example, the XMPP protocol to tether a credit network agent 115 on the device 150 to a server 160. The server 160 can then issue commands to the mobile device on request. The mobile user interface framework to access certain components of the system 100 may be based on XHP, Javelin, or WURFL. In another example mobile implementation for OS X and iOS operating systems and their respective APIs, Cocoa and Cocoa Touch may be used to implement the client side components 115 using Objective-C or any other high-level programming language that adds Smalltalk-style messaging to the C programming language.

Disk storage 117 provides non-volatile storage for computer software instructions 115 (equivalently “OS program”) and data 116 used to implement embodiments of the system 100. Central processor unit 112 is also attached to system bus 110 and provides for the execution of computer instructions.

In one embodiment, the processor routines 115 and data 116 are computer program products, e.g. credit protocol application 332, foundation application 505, smart contracts, and trust scoring engine (generally referenced 115), including a computer readable medium capable of being stored on a storage device 117, which provides at least a portion of the software instructions for the device identification system 100. Executing instances of respective software components of the credit protocol system 100, such as instances of credit protocol application, foundation application, smart contracts, and trust scoring engine may be implemented as computer program products 115, and can be installed by any suitable software installation procedure, as is well known in the art. In another embodiment, at least a portion of the system software instructions 115 may also be downloaded over a cable, communication and/or wireless connection via, for example, a browser SSL session or through an app (whether executed from a mobile or other computing device). In other embodiments, the system 100 software components 115 may be implemented as a computer program propagated signal product embodied on a propagated signal on a propagation medium (e.g., a radio wave, an infrared wave, a laser wave, a sound wave, or an electrical wave propagated over a global network such as the Internet, or other network(s)). Such carrier medium or signals provide at least a portion of the software instructions for the present credit protocol system 100.

### Distributed Ledger (Blockchain) Network

FIG. 2 illustrates a decentralized distributed ledger (blockchain) network 200 accessed in embodiments of the present invention. A distributed ledger peer-to-peer network 200, such as shown in FIG. 2, is valuable because this network enables trustworthy processing and recording of transactions without the need to fully trust any user (e.g., person, entity, program, and the like) involved in the transactions, reducing the need for trusted intermediaries to facilitate the transaction. Existing applications use the distributed ledger network 200 to transfer and record the movement of digital money in the form of blockchain based records, such as tokens or Bitcoins, known as cryptocurrency. Embodiments of the present invention expand the use of the distributed ledger network 200 to securely create, record, and track debt and credit transactions between users in the distributed ledger network 200.

The distributed ledger network 200 comprises multiple computing devices configured as nodes 210, 220, 230, 240, 250, 260 of the distributed ledger network 200. Each node 210, 220, 230, 240, 250, 260 locally stores and maintains a respective identical copy 215, 225, 235, 245, 255, 265 of the blockchain ledger in memory communicatively coupled to the node. The nodes exchange messages within in the distributed ledger network 200 to update and synchronize the ledger stored and maintained by each node. The nodes may also execute decentralized applications (e.g., via smart contracts) for processing the messages. A message transmission 270 from node 210 to node 240 in distributed ledger network 200 is shown in FIG. 2. The dotted lines between each set of nodes in the distributed ledger network 200 indicate similar transmissions may be exchanged between any other set of nodes in the distributed ledger network 200. The messages may contain a confirmed debt or credit transaction for recording, a verified payment on a recorded debt transaction for recording, a verified expense on a recorded credit transaction for recording, a relationship between the users of a recorded debt or credit transaction, and such.

### Credit Protocol System

FIG. 3 illustrates a credit protocol system 300 that communicates with the distributed leger system 200 of FIG. 2 to record and track debt (or credit) transactions.

In the credit protocol system 300, a first user (user 1 305) possesses a first user device, user device (node) 1 310, configured with a user application 308 associated with the credit protocol, which communicates with the credit protocol application 332 executing on the server 330. User 1 305 may be a person, entity, program, system, or such. User 1 305, via the user application 308, may register with the credit protocol application 332 executing on server 330. To register, user 1 305 via user application 308 may transmit, through communication connection 312, a request containing a unique user identifier 306 (e.g., a unique public key of the blockchain, or unique text string identifier associated with one or more public keys of the blockchain) to the credit protocol application 332. To verify that user 1 305 owns the transmitted user identifier 306, user 1 305, through communication connection 312, signs a transaction for the user identifier 306 (e.g., using one or more blockchain private keys that cryptographically pair with the one or more blockchain public keys of the user identifier 306) with the credit protocol application 332. If user identifier 306 is successfully verified for user 1 305, the credit protocol application 332 stores an account or profile for user 1 305, including user identifier 306, in memory communicatively coupled to the server 330. The credit protocol application 332 may further record the registration of the distributed blockchain ledger network 200 (e.g., at nodes 250 and 260 shown in FIG. 3) through communication connection 334.

Similarly, a second user (user 2 315) possesses a second user device, user device (node) 2 320, configured with a user application 318 of the credit protocol, which communicates with the credit protocol application 332 executing on the server 330. User 2 315, via the user application 318, may register with the credit protocol application 332 executing on server 330. User 2 315 may be a person, entity, program, system, or such. To register, user 2 315 via user application 318 may transmit, through communication connection 322, a request containing a unique user identifier 316 (e.g., a unique public key of the blockchain, or unique text string identifier associated with one or more public keys) to the credit protocol application 332. To verify that user 2 315 owns the transmitted user identifier 316, user 2 315 via user application 318, through communication connection 322, signs a transaction for the user identifier 316 (e.g., using one or more blockchain private keys that cryptographically pair with the one or more blockchain public keys of the user identifier 316) with the credit protocol application 332.

If user identifier 316 is successfully verified for user 2 315, the credit protocol application 332 stores an account or profile for user 2 315, including user identifier 316, in memory communicatively coupled to the server 330. The credit protocol application 332 may further record the registration in the distributed blockchain ledger network 200 (e.g., at nodes 250 and 260 shown in FIG. 3) through communication connection 334. In some embodiments, user 1 305 and user 2 315 may use the credit protocol application 332 to record and track debt and credit transactions without registering with the credit protocol application 332. In these embodiments, the users 305 and 315 may sign transactions for the respective user identifier 306, 316 as a first debt transaction (or periodic debt transactions) using the credit protocol application 332. If the signatures are verified, the credit protocol application 332 may store or cache the user identifiers 306, 316 in memory communicatively coupled to the server 330 for further debt transactions by the users 305, 315.

Once registered with the credit protocol application 332, user 1 305 and user 2 315 may participate in debt or credit transactions facilitated by the credit protocol application 332. In some embodiments, the credit protocol application 332 must establish a relationship/edge between user device 1 310 of user 1 305 and user device 2 320 of user 2 315 prior to user 1 305 participating in a debt/credit transaction with user 2 315. The establishment of such a relationship/edge between user device 1 310 and user device 2 320 is described in the “Debt/Credit Transactions using Foundation Identifiers” section in reference to FIGS. 5A-5C. In other embodiments, user 1 305, via the credit protocol application 332, may record pending debt or credit with user 2 315 or any other pending debt or credit in a centralized holding place or area (e.g., a server, computer memory coupled to the credit protocol application 322, and the like), or in the blockchain 200 (rather than participate in the debt or credit transaction with user 2 315).

In an example scenario, user 1 305 and user 2 315 may be having dinner together in a restaurant, and when the waiter delivers the bill for the dinner, user 2 315 learns that he forgot his wallet. User 1 305 pays the bill with the agreement (e.g., IOU) that user 2 315 will owe user 1 305 the cost of user 2′s meal (i.e., user 1 305 will credit user 2 315 this cost). To record this debt agreement, user 1 305, via user application 308 configured on user device 1 310, sends a request for a respective debt transaction with user 2 315. The debt transaction request may contain the identification of user 1 305 as the creditor, identification of user 2 315 as the debtor, the amount of the debt, the currency of the debt, date/time of the request, and such. The sending of the debt transaction request by user 1 305 evidences user l′s confirmation of the debt transaction. In some embodiments, the debt transaction request may be transmitted, through communication connection 312, to the credit protocol application 332, where validation may be performed on the debt transaction prior to forwarding, through communication connection 322, to user 2 315 via user application 318 configured on user device 2 320. In other embodiments, the debt transaction request may be transmitted via user application 308 configured on user device 1 310, through communication connection, 314, directly to user 2 315 via user application 318 configured on user device 2 320.

User 2 315, via the user application 318, receives the debt transaction request, and confirms, via the user application 318, the debt transaction (e.g., by pressing a button available on a user interface of the user application 318 or other such option). The actions of user 2 315 via user application 318 evidences user 2′s confirmation of the debt transaction. The debt transaction is thereby bilaterally confirmed by both user 1 305 and user 2 315. The user application 318 transmits, through communication connection 322, the bilaterally confirmed debt transaction to the credit protocol application 332, where validation may be performed on the debt transaction prior to recording. If validated (or no validation is performed), the credit protocol application 332, through communication connection 334, records the bilaterally confirmed debt transaction in the distributed blockchain ledger network 200 (e.g., nodes 250 and 260 shown in FIG. 3) associated to user identifier 306 of user 1 305 and user identifier 316 of user 2 315. In some embodiments, the transaction data recorded, includes, but is not limited to, the debt amount, debtor identity, creditor identity, debtor and creditor relationship, the time of the debt transaction, the currency of the debt, and such. In some embodiments, the credit protocol application 332 records the debt transaction encrypted.

At some later time, user 2 315 may make a payment to user 1 305 toward part of all of the recorded debt transaction. User 2 315, via user application 318 configured on user device 2 320, may then send a verification of the payment transaction to user 1 305. The payment transaction verification may contain the identification of user 1 305 as the creditor, identification of user 2 315 as the debtor, the amount of the debt, the currency of the debt, date/time of the associated debt transaction, and such. The sending of the payment transaction verification by user 2 315 evidences user 2′s confirmation of the payment toward the debt transaction. In some embodiments, the payment transaction request may be transmitted, through communication connection 322, to the credit protocol application 332, where verification may be performed on the payment transaction prior to forwarding, through communication connection 312, to user 1 305 via user application 308 configured on user device 1 310. In other embodiments, the payment transaction request may be transmitted via user application 318 configured on user device 2 320, through communication connection, 314, directly to user 1 305 via user application 308 configured on user device 1 310.

User 1 305, via the user application 308, receives the payment transaction verification, and confirms, via the user application 308, the payment transaction (e.g., by pressing a button available on a user interface of the user application 308 or other such option). The actions of user 1 305 via user application 308 evidences user 1's confirmation of the payment transaction. The payment transaction is thereby bilaterally confirmed by both user 1 305 and user 2 315. The user application 308 transmits, through communication connection 312, the bilaterally confirmed payment transaction to the credit protocol application 332, where validation may be performed on the debt transaction prior to recording. If validated (or no validation is performed), the credit protocol application 332, through communication connection 334, locates the previously confirmed debt transaction between user 1 305 and user 2 315. If the located debt transaction is encrypted, the credit protocol application 332 executes instructions to decrypt the transaction data. The credit protocol application 332 records the bilaterally confirmed payment transaction in the distributed blockchain ledger network 200 (e.g., at nodes 250 and 260 shown in FIG. 3) associated to the previously confirmed debt transaction and user identifiers 306 and 316. In some embodiments, the credit protocol application 332 records the payment transaction encrypted.

### Smart Contracts

In some embodiments, the credit protocol application 332 executes programs or applications, known as smart contracts, which impose parameters or guidelines for validating and recording debt transactions. In some embodiments, when a user (e.g., user 1 305) sends a request for a debt transaction or a user (e.g., user 2 315) sends a verification of a payment, the credit protocol application 332 executes one or more smart contracts to validate the request or verification prior to receipt by the recipient user. In some embodiments, the credit protocol application 332 instead or in addition executes a smart contract to validate a bilaterally confirmed debt transaction or payment transaction prior to recording in the distributed blockchain ledger network 200. In embodiments, the nodes of the distributed blockchain ledger network 200 (e.g., nodes 250 and 260 shown in FIG. 3) are configured to execute a smart contract to validate the bilaterally confirmed debt transaction or payment transaction prior to recording in the distributed blockchain ledger network 200. In some embodiments, the credit protocol application 332 records the validation (or failed validation) of a transaction to the distributed blockchain ledger network 200 along with the debt transaction or payment transaction. In some embodiments, the credit protocol application 332 records pending debt or credit in a centralized holding place or area (e.g., a server, computer memory coupled to the credit protocol application 322, or the like), or in the blockchain 200 (rather than participate in a bilaterally confirmed debt transaction).

In some embodiments, the credit protocol application 332 executes a smart contract, known as a Use Case Authority Contract (UCAC), which is configured with certain validation parameters (factors), including, but are not limited to, transaction amount, debtor identity, creditor identity, debtor and creditor relationship, date/time of the transaction, the currency of the debt, and such. Some of these validation parameters may be globally defined by the UCAC or credit protocol application 332 for all transactions. For example, the UCAC may be globally configured to only validate transactions below $100,000 and in U.S. currency. Some of these validation parameters may be specifically defined for a user or a set of users, through interaction by the user or users, or through interaction with a person, entity, program, system, or such associated with the user or users via the UCAC or another smart contract communicatively coupled to the UCAC. For example, the UCAC may be defined for an entity user to only accept debt transactions from a list of particular other entities, and the debt transactions must be below $1 million and only occur on Fridays before noon eastern standard time. The defined parameters may be associated to a particular user (e.g., user 1 305) based on the user identifier (e.g., user identifier 306) of the user.

In some embodiments, when the credit protocol 332 receives a debt transaction request from a user (e.g., user 1 305), the credit protocol 332 executes the UCAC on a blockchain node 250 or 260, through communication connection 334. The UCAC checks the configured validation parameters against data of the debt transaction request to determine whether the debt transaction request is valid based on the validation parameters. If the validation parameters of the UCAC do not meet the debt transaction data, the credit protocol application 332 will not forward the request to user 2 315 for confirmation. In other embodiments, when the credit protocol 332 or node of the distributed blockchain ledger 200 receives a confirmed debt transaction from user 2 315, the credit protocol 332 executes the UCAC, through communication connection 334 on a blockchain node, which checks the configured validation parameters against data of the confirmed debt transaction to determine whether the debt transaction is valid based on the validation parameters. In this embodiment, if the validation parameters of the UCAC do not meet the confirmed debt transaction data, the credit protocol application 332 or nodes (e.g., nodes 250 and 260) of the distributed blockchain ledger 200 will not record the confirmed debt transaction in the distributed blockchain ledger 200 (or will record it marked as invalid).

For example, if the UCAC is configured to only allow debt transactions denominated in U.S. dollars, but a user 1 305, via the credit protocol application 332, attempts to send or record a debt in Chinese yuan, the credit protocol application 332, by execution of the UCAC, will determine the debt transaction to be invalid. The credit protocol application 332 will either not send the debt transaction for confirmation or not record the confirmed debt transaction in the distributed blockchain ledger 200 (or record it as invalid in the distributed blockchain ledger 200).

Similarly, in some embodiments, when the credit protocol 332 receives a payment transaction verification associated to a recorded debt transaction from a user (e.g., user 2 315), the credit protocol 332 executes the UCAC, through communication connection 336, which checks the configured validation parameters against data of the payment transaction verification to determine whether the debt transaction request is valid based on the validation parameters. If the validation parameters of the UCAC do not meet the payment transaction data, the credit protocol application 332 will not forward the verification to user 1 305 for confirmation. In other embodiments, when the credit protocol 332 or node of the distributed blockchain ledger 200 receives a confirmed payment transaction from user 1 305, the credit protocol 332 executes the UCAC, through communication connection 334 on a blockchain node, which checks the configured validation parameters against data of the confirmed payment transaction to determine whether the confirmed payment transaction is valid based on the validation parameters. In this embodiment, if the validation parameters of the UCAC do not meet the confirmed payment transaction data, the credit protocol application 332 or nodes (e.g., nodes 250 and 260) of the distributed blockchain ledger 200 will not record the confirmed payment transaction in the distributed blockchain ledger 200 associated to the recorded debt transaction (or record it marked as invalid).

In some embodiments, the credit protocol application 332 (or nodes of the distributed blockchain ledger 200) also executes smart contracts to perform tasks like tracking pending debt/credit amounts between users (debtors and creditors). To do so, the credit protocol application 332 may execute the smart contracts to read transaction data from other smart contracts, such as reading other issued/pending debt of users of the credit protocol application 332, confirming the creation of a debt by one user by tracking confirmation of a debt transaction request by another user, reading a list of users having relationships (connection) with a particular user, tracking changing relationships (connections) of particular users, tracking currency and date/time of particular recorded debts, and such. In some embodiments, one or more of the smart contracts may track the relationship between two users (whether the two users have a configured relationship), such that two users must be identified as having a relationship in order to execute a debt transaction request or record a debt transaction.

### Credit Protocol Method

FIG. 4 illustrates an example credit protocol method 400 for recording and tracking debt (or credit) transactions in a blockchain in embodiments of the present invention. In embodiments, the credit protocol system 300 of FIG. 3 and distributed blockchain ledger network 200 executes the credit protocol method 400 of FIG. 4.

The method 400 begins at step 405, with a first user (e.g., user 1 305) signing a transaction to verify ownership of a user identifier (e.g., public blockchain key or text string identifier comprising one or more public blockchain keys). The first user signs the transaction, via a user application executing on a computing device of the first user (e.g., computing device 1 310), which transmits the signed transaction for verification by the credit protocol application 332. The first user may sign each public blockchain key by using a blockchain private key that cryptographically pairs with the blockchain public key.

If the credit protocol application 332, at step 415 of method 400, determines that the first user cannot sign the public key, then the credit protocol application 332 of method 400, at step 420, stops the debt transaction. Otherwise, if the credit protocol application 332, at step 410 of method 400, determines that the first user can sign the public key, then the credit protocol application 332, at step 425 of method 400, enables the first user to send a debt transaction request to a second user (e.g., user 2 315) via the user application on the second user's computing device, or record pending debt or credit in a centralized holding place or area (e.g., a server, computer memory coupled to the credit protocol application 322, or the like) or the blockchain. In some embodiments, the first user, via the credit protocol application 332, must establish a relationship/edge between the first user's computing device and the second user's computing devices (as described in the “Debt/Credit Transactions using Foundation Identifiers” section in reference to FIGS. 5A-5C) in order to be enabled to send the debt transaction.

The debt transaction request may include data, including a debt amount provided by the first user via the user application, the first user's identity as creditor, the second user's identity as debtor, the debt currency provided by the first user, the date/time of the debt transaction request, and such. In some embodiments, by signing the transaction in step 405, the first user registers with the credit protocol application 332, and an account or profile for the first user (including the user's verified public blockchain key) is stored in memory communicatively coupled to the credit protocol application 332.

The second user, via a user application on the second user's computing device (e.g., computer device 2 320) receives the debt transaction request. In some embodiments, the second user is also a registered user with the credit protocol application 332, having an account or profile that includes a user identifier comprising one or more verified public blockchain public keys for the second user. In other embodiments, the second user must sign a transaction to verify ownership of each public blockchain key, on receipt of the debt transaction request. The second user, via the user application on the second user's computing device, may confirm or deny the debt transaction of the request. If the second user denies the debt transaction at step 435 of method 400, then the credit protocol application 332, at step 440 of method 400, stops the debt transaction. Otherwise, if the second user confirms the debt transaction at step 430 of method 400, then at step 445 of method 400, the credit protocol application 332 validates the confirmed debt transaction.

To perform the validation, the credit protocol application 332 may execute a smart contract (e.g., Use Case Authority Contract (UCAC)) configured with validation parameters, including general rules or user-specific rules for validating a debt transaction. For example, the UCAC may include general rules that a debt transaction executed by the credit protocol application 332 cannot be validated for over $500,000 or on dates of U.S. federal holidays. The UCAC may also include defined rules that a blockchain public key of the user identifier of the first user cannot participate in transactions as a creditor and a blockchain public key of the user identifier of the second user cannot participate in transactions in the currency of Japanese yen. The UCAC executed by the credit protocol application 332 compares the data of the debt transactions to the configured validation parameters to determine whether the debt transaction meets the configured validation parameters of the UCAC.

If at step 455 of method 400, the credit protocol application 332 determines that the validation fails, then, at step 460 of method 400, the credit protocol application 332 stops the debt transaction. For example, if the debt transaction includes data that the transaction is in Japanese yen and the validation parameter of the UCAC indicate that a blockchain public key of the user identifier of the second user cannot participate in transactions in Japanese yen, then credit protocol application 332 stops the debt transaction. Otherwise, if at step 450 of method 400, the credit protocol application 332 determines that the validation succeed, then, at step 465 of method 400, the credit protocol application 332 records the confirmed debt transaction. The credit protocol application 332 records the confirmed debt transaction in the blockchain (e.g., at nodes of the distributed blockchain ledger network 200 of FIG. 2) associated to the user identifier (e.g., to blockchain public keys of the user identifier) of the first and second users. The credit protocol application 332 may also store or cache the confirmed debt transaction in another memory device or location communicatively coupled to the credit protocol application 332.

The second user (debtor) may then make one or more payment transactions against the confirmed debt transaction, or the first user (creditor) may then make one or more expense transaction against the confirmed debtor. Verification of payment transactions may be sent from the second user (debtor), confirmed by the first user (creditor), and recorded in the blockchain associated to the corresponding debt transaction using similar steps as method 400. Further, verification of expense transactions may be sent from the first user (creditor), confirmed by the second user (debtor), and recorded in the blockchain associated to the corresponding debt transaction using similar steps as method 400.

### Credit Protocol Tokens

In some embodiments, the smart contracts (e.g., UCACs) executing the debt and credit transactions include a validation parameter requiring users to provide proof of ownership of associated tokens, known as Credit Protocol Tokens (CPT), in order to use the credit protocol application 332 to record transactions. Each CPT may enable a user to record a given number of transactions (proportional to the amount of CPT owned) per given time period in the distributed blockchain ledger 200. In these embodiments, the smart contracts, based on the configured validation parameters, check for the existence of a CPT associated with the transaction, and the number of outstanding transactions available for the user to execute with the CPT within a given time period. If the transaction does not include an associated CPT or the user has exceeded the number of transactions available for the CPT (or does not have sufficient CPT to execute the transaction), the smart contract will stop the transaction from being recorded in the distributed blockchain ledger 200. In some embodiments, the validation parameters of the smart contract may include a parameter enabling an owner of a CPT to volunteer or sell transactions, in proportion to the amount of CPT owned, to other users of the credit protocol application 332 or smart contract (UCAC).

In some embodiments, the smart contract system may require a user (person, entity, program, system, and such) to associate with one or more CPTs owned by another user in order to utilize the credit protocol application 332 to record debt or credit transactions and data. In some embodiments, a smart contract records information about which entities own CPTs, how many CPT are owned by each of those entities, and/or how many CPT are staked or associated from one entity to another.

In some embodiments, a smart contract may exist to allow the periodic settling (payment) of debts or credits through payment of currency from a digital wallet of one user to the digital wallet of another connected user. In some embodiments, a smart contract may exist to allow a user to send debt or credit transactions to a group of connected users, with the debts and credits split among the users.

Debt/Credit Transactions using Foundation Identifiers

FIG. 5A is a block diagram of the foundation system 500 for generating a unitary user identifier in example embodiments of the present invention. A user 502 via a computing device (node) 504 communicates in the foundation system 500. The foundation system 500 includes a server 503 configured with the foundation application 506 communicatively coupled to the credit protocol application 332. In other embodiments, the foundation application 506 and credit protocol application 332 may be configured (and communicatively coupled) across multiple servers. The foundation system 500 further includes a plurality of accounts 511, 513, 515 (e.g., for different decentralized applications) stored on nodes 510, 512, 514 of the distributed blockchain ledger network (i.e., blockchain network) 200. The foundation system 500 may also include one or more accounts for one or more computing devices (nodes) of the user 502.

In some embodiments, the foundation application 506 of system 500 generates a master unitary user identifier (e.g., text identifier) 508 for user 502 from one or more blockchain public addresses (or in some embodiments, private addresses) corresponding to the one or more nodes (computing devices, including node 504) associated with the user 502. In some embodiments, the foundation application 506 of system 500 generates a master unitary user identifier 508 for the user 502 from one or more blockchain public addresses (or in some embodiments private addresses) corresponding to one or more blockchain nodes in the blockchain ledger network 200. The master unitary user identifier of these embodiments enables the user to sign into multiple decentralized applications executed on blockchain nodes with one login credential (similar to how web apps allow a user to sign in by Facebook or Google), for example for securely executing, validating, recording, and tracking a debt or credit transaction via the credit protocol application 332.

To generate the master unitary user identifier 508, the user 502 provides blockchain public node addresses associated to the user's computing devices (including user node 504) or blockchain nodes to foundation application 506 through communication connection 517. In other embodiments, the foundation application 506 may automatically resolve these public node addresses over respective computer networks. Each public address is associated with a unique blockchain public key in a public-private cryptological key pair. The foundation application 506 includes a security feature that verifies if the user owns the one or more provided (resolved) public addresses. To do so, the foundation application 506, through communication connection 517, requests that the user authenticate the user's ownership of each public address by signing a transaction for the associated public key. To sign the transaction, the user/node 504 must use the corresponding private key of the public-private cryptological key pair. The foundation application 506 creates an association between each authenticated blockchain public address to generate a unique text-defined user identifier (i.e., master unitary user identifier) for the user 502. The user 502 via user 502/node 504 may further add or delete public addresses from the user identifier by similarly authenticating ownership of the added or delete public address by signing a transaction for the associated public key.

The foundation application 506 stores the generated (or updated) user identifier (i.e., master unitary user identifier) in a central registry 525 (as shown in FIG. 5B) in the blockchain network 200. Any user/node with access rights to the blockchain may query the central registry 525 to determine whether a particular master unitary user identifier is associated with a particular public address, or if a particular public address is associated with a particular master unitary user identifier.

FIG. 5B is a block diagram of a system 520 for establishing relationships between nodes in a blockchain network using user identifiers generated by the foundation system 500 of FIG. 5A. The system 520 includes a central registry 525 in the blockchain network 200 that stores generated user identifiers. The system 520 also includes computing device (nodes) 504 and 540 of users 502 and 542, respectively.

FIG. 5C is a flowchart of the method 550 used by system 520 to establish relationships between the nodes 504 and 540 of FIG. 5B. Method 550 begins at step 551 with computing device (node 1) 504 of registered user 1 502 declaring a relationship (“friendship”) or edge with computing device (node 2) 540 (of user 2 542 registered with the credit protocol application 332). Method 550, at step 552, authenticates node 1 and related data, by executing the foundation application 506 to query the central registry 525 to locate the master unitary user identifier 505 associated to user 1 502 (the user identifier 505 was previously created according to FIG. 5A). Step 552 checks the located user identifier 505 to determine if the public address of the computing device (node) 504 is included in the user identifier 505. If included in the user identifier, step 552 may verify user 1's ownership of the public address of node 1 504 by signing a transaction for the associated public key identified in the user identifier 505 using the corresponding private key. If user 1's ownership is not verified at step 556 of method 550, step 558 of method 550 stops the establishment of the relationship. Otherwise, if user 1's ownership is verified at step 554 of method 550, step 560 of method 550 transmits the declaration of the relationship or edge to node 2 540.

Once received at node 2 540, step 562 of method 550 authenticates node 2 540 and related data, by executing the foundation application 506 to query the central registry 525 to locate the master unitary user identifier 541 associated to user 2 542 (the user identifier 541 was previously created according to FIG. 5A). Step 562 checks the located user identifier 541 to determine if the public address of the computing device (node) 540 is included in the user identifier 541. If included in the user identifier 541, step 562 may verify user 2′s confirmation of the relationship/edge and ownership of the public address of node 2 540 by signing a transaction for the associated public key identified in the user identifier 541. At step 564 of method 550, node 2 540 further responds to the declaration by node 1 504, including the status of the authentication, which is forwarded to the foundation application 506. If the authentication status indicates user 2′s ownership is not verified at step 568 of method 550, step 570 of method 550 stops the establishment of the relationship. Otherwise, a relationship/edge is established between node 1 504 and node 2 540, as shown by relationship/edge 526 in system 520 of FIG. 5B. The validated relationship/edge 526 is stored at step 572 of method 550 (e.g., in the blockchain ledger network 200 of FIG. 2).

At step 574 of method 550, once the relationship/edge 526 is established, user 1 502 (via node 1 504) may initiate a debt/credit transaction based on the relationship/edge 526, as shown at 528 in system 520 of FIG. 5B. The debt/credit transactions based on (or through) the relationship/edge 526 may be performed according to system 300 of FIG. 3 or method 400 of FIG. 4. The transaction performed based on the relationship/edge 526 is depicted at 528 of FIG. 5B, and may include transaction data/criteria such as: (1) amount of credit/debt, (2) direction owed (from one entity to another), (3) currency, 4) attributes of credit/debt, and (5) address or user identifier of node 2 540. Further validation may be performed on the transaction based on the relationship/edge 526 (e.g., the execution of smart contracts, such as UCACs) using validation parameters described in reference to FIG. 3. At step 574 of method 550, the relationship/edge 526 is made available to other applications operating the credit protocol application 332 (such as App 1 532 and App 2 534 of FIG. 5B, and the FID or Gift Chain of FIG. 5C) from the central registry 525, as shown at 530 in system 520 of FIG. 5B.

### Method and System of Attesting User and User Identifier

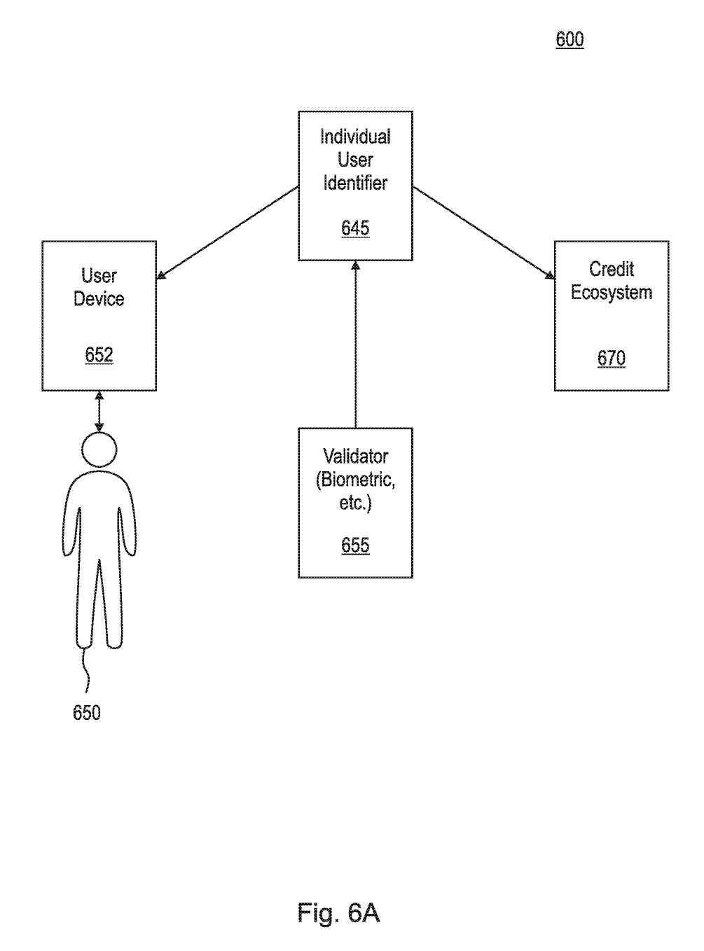

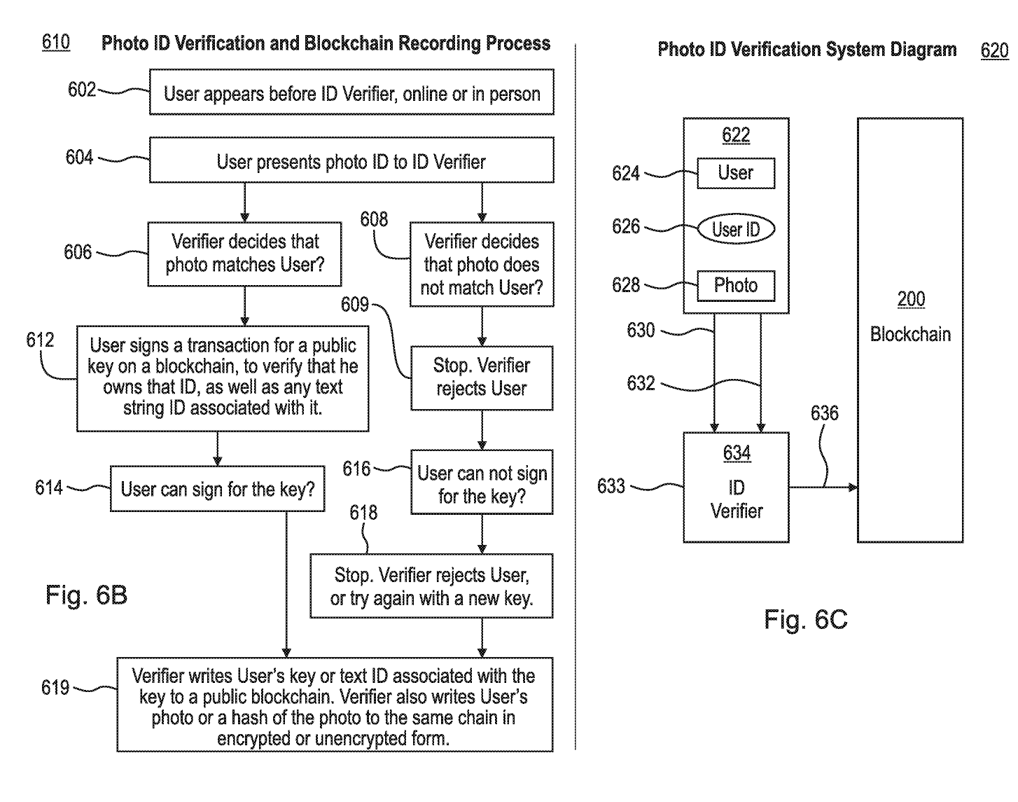

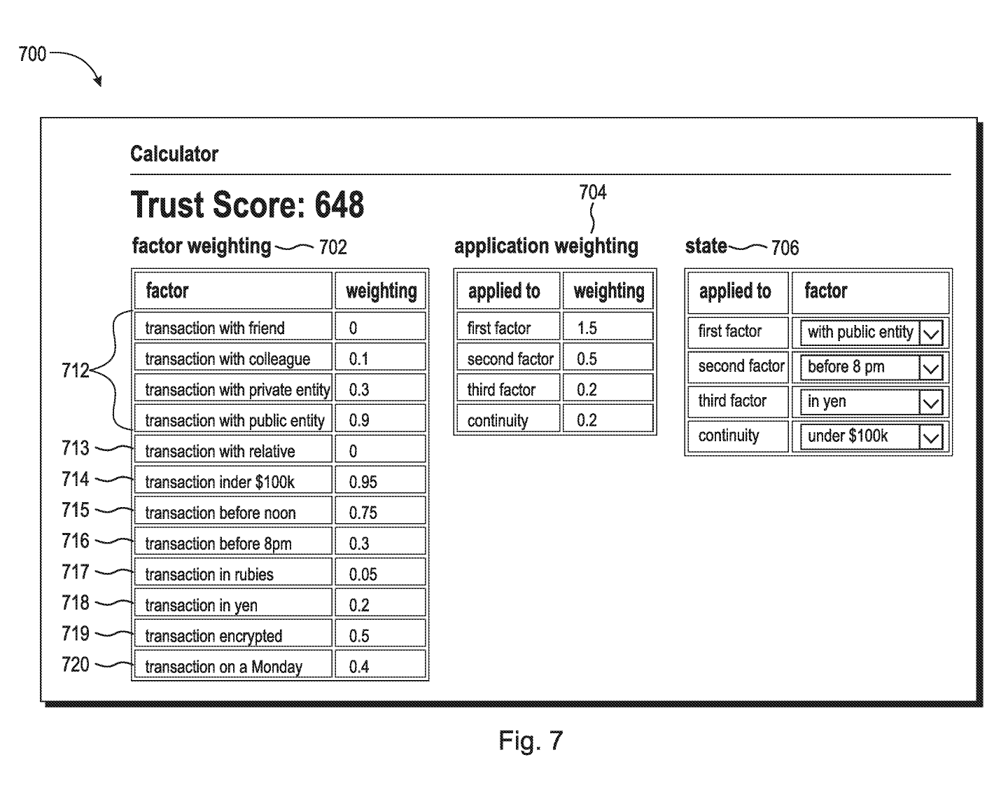

FIG. 6A is a method 600 of attesting the identity and the individual user identifier 645 of a user 650 registering via user device 652 to use the credit protocol application in example embodiments of the present invention. The method 600 may be used in example embodiments of the credit protocol systems and methods (as shown in FIGS. 3, 4, and 5A-5C). As shown in FIG. 6A, when a user 650 (e.g., person, entity, system, or such) registers with the credit protocol application 332, the credit protocol application 332 implements a validator 655 to attest to the identity of the user 650 (i.e., to attest that the user is the person, entity, program, system, or such that the user claims to be). The validator 655 may be a human, system (e.g., via a program or application), or such that collects data related to the identity of the user, and uses the data to attest to the identity of the user 650. For example, the validator 655 may collecting fingerprint, voiceprint, images (e.g., photos or video), eye scans, dental scans, or such samples from the user 650 via user device 652 (e.g., via a user application 308, 318 executing on the computing device 310, 320 of the user 305, 315 of FIG. 3), and comparing the collected samples to data on record for the user 650 (e.g., in the blockchain or any other database accessible to the validator 655). For another example, the validator 655 may also request from the user 650: a date of birth, data on current financial assets and resources of the user, and such, which the validator 655 compares to data on record for the user (e.g., in the blockchain or any other financial, medical, or other such database accessible to the validator 655). The credit protocol application 332 may record the results of the attestation in the blockchain, and may include the collected samples/data, other data used for the attestation, an identifier associated with the validator, and such.

If the credit protocol application 332 successfully attests the identity of the user, the validator 655 then attests that the user identifier 645 is provided for registering the user 650 with the credit protocol application 332. The user identifier 645 is a single, unique identifier 645 associated exclusively and permanently to the user 650. That is, based on the user's attested-to identity, the validator 655 searches the credit protocol accounts, the blockchain, and any other accessible data source to locate other user identifiers associated to the user 650 and that the credit protocol application 332 and related application, such as the foundation application 506, relied on in relation to the user 650). In some embodiments, the user identifier 645 is a master unified user identifier of FIG. 5A containing multiple addresses associated to multiple user devices enabled to execute and record transactions of the user 650 via the credit protocol application 332. In these embodiments, the validator 655 searches accessible data sources to determine that other user identifiers (including the different public keys associated with the different addresses of the master unified user identifier) are not relied on by the credit protocol application 332 or related applications. In other embodiments, the user identifier 645 is associated with only a single address of a single user device (e.g., user device 652) enabled to execute and record transactions of the user 650 via the credit protocol application 332.

The validator 655 further attests from the accessible data sources that the registering user 650 is the only (exclusive) user that the credit protocol application 332 and related applications rely on in association with the user identifier 645. That is, the validator 655 determines that user 650 owns user identifier 645 and that no other user (e.g., person, entity, system, and such) has use of the user identifier 645. If the validator 655 determines that the user identifier is the single, unique identifier that is exclusively used by the user 650 in association with the credit protocol application 332, the validator 655 persistently (permanently) stores the user identifier 645 in the blockchain associated to the attested-to user identity and accessible to the credit protocol application 233. In this way, the recorded user identifier 645 permanently traces to only the single user 650 and then can be used to associate certain persistent properties and transactions of the user 650, such as the user's birth date, loans taken by the user, user's default on a loan, user's assets, user's income, and such.

The permanent recordation of the user identifier 645 associated to these persistent properties of the user 650 in the blockchain is then part of credit ecosystem 670 as a permanent identifier of the user 650. A credit scoring application, coupled to the credit protocol application 332, may use the permanent association to enable creditors (lenders) to prove that debtors (borrowers) do not have unknown financial resources, such as additional, unknown lines of credit or debt and compare the lines of credit to the cash flows, income, assets, and such of the user 650. For example, the credit scoring application may search the permanent records to locate and provide the complete financial history of a user 650 to a creditor (lender), or may use the complete located financial history to generate and provide a credit score to the creditor (lender), or such. The permanence of the recordation and attested-to exclusivity of the user identifier 645 to the user provides the assurance (proof) that the associated user properties used by the credit scoring application are complete and accurate for the user 650, and that no other users have claims against the associated properties.

### Method and System of Verifying User Identification

FIG. 6B is an example method 610 of verifying identity of a user for executing and recording debt and credit transactions in embodiments of the present invention (which may be executed as part of the method 600 of FIG. 6A). The method 610 begins at step 602 with a user appearing before an identification verifier (or identification validator). In some embodiments, the identification verifier is an application or program of an online or other automated identification service (i.e., a virtual identification verifier), which automatically verifies the user's identity without human intervention. In other embodiments, the identification verifier is a human (for example, employed at an identification agency), who may use automated tools/applications for verifying the identity of the user. In some embodiments, the user appears online to the identification verifier (e.g., the user communicates through a user service application on a user device to the online identification service, and a virtual or human identification verifier of the online identification service performs the verification). In other embodiments, the user appears in person to the identification verifier (e.g., physically appears to a human identification verifier at a physical location).

At method 610, step 604, the user presents a form of user identification to the identification verifier. The user may present the user identification through the user service application executing on the user device to the identification verifier (virtual or human), or the user may physically present the user identification in person to the human identification verifier. In method 610, the presented user identification is any form of photo identification (e.g., license, passport, credit card with photo, identification card, and the like), however, in other embodiments the presented user identification may be voice identification, handwriting identification, and any other type of user identification without limitation. The identification verifier then determines/decides whether the user identification presented in step 204 matches physical characteristics of the user. For example, in the case of the presented photo identification, a human identification verifier may decide through visual inspection whether the photo matches the facial characteristics of the user through in person or online appearance of the user in step 602. For a further example, a virtual identification verifier of an online service may make the determination by digitally or biometrically comparing the photo identification to the physical characteristics (facial characteristics) of the user appearing to the identification verifier through the online identification service.

At method 610, step 608, the identification verifier determines that the photo identification does not match the physical characteristics of the user, and at step 609 stops method 610 and rejects the verification of the user. At method 610, step 606, the identification verifier instead determines that the photo identification does match the physical characteristics of the user and proceeds with steps of recording the user identification in a public blockchain. Note in FIG. 6B, the method 610 records the user identification in a public blockchain, but in other embodiments the identification verifier may record the user identification in a private blockchain.

To record the verification, at method 610, step 612, the user signs a transaction with the private key for a unique public key on the blockchain, thereby verifying that the user owns the unique public key, as well as any unique text string identifier associated with the public key. At method 610, step 616, if the identification verifier determines that the user cannot sign for the public key (e.g., cannot provide proper authentication, such as the private key, related to the public key), then, at step 618, the identification verifier stops the method 610 and rejects the verification of the user. The user may proceed back to step 612, and attempt to complete verification with a different public key. At method 610, step 614, if the identification verifier instead determines that the user can sign for key (e.g., can provide proper authentication related to the public key), then, the identification verifier proceeds to record the presented user identification. Note, in some embodiments, the identification verifier performs the steps of verifying the user's public key and any associated text string identifier (steps 612-618) prior to performing the steps of verifying the user identification (steps 602-610).

At method, step 619, the identification verifier records (writes) the user's public key, or an associated text string identifier, to the blockchain (e.g., public blockchain). At step 619, the identification verifier also records the user identification (e.g., photo identification), or a calculated cryptographic hash of the user identification, to the same chain in the blockchain, thereby associating the user identification (or calculated cryptographic hash of the user identification) to the user's public key (or associated text string identifier) in the blockchain. In some embodiments, the identification verifier records the user identification (or calculated cryptographic hash of the user identification) encrypted in the blockchain, and in other embodiments, the identification verifier records the user identification (or calculated cryptographic hash of the user identification) unencrypted in the blockchain.

FIG. 6C is a system 620 that verifies and records user identification in an example embodiment of the present invention. In some embodiments, the system 620 executes the method 610 of FIG. 6B to verify and record the user identification. The system 620 includes a device 622 (e.g., mobile device, personal computer, tablet, or the like) of a user 624, which executes a user service application that enables the user 624 to communicate with an online identification service 634 executing on a verification server 633. The user 624 possesses a unique user identifier 626 (e.g., a unique public key of the blockchain, or unique text string identifier associated with one or more public keys as described in FIGS. 5A-5C), and a form of photo identification 628 acceptable to an identification verifier (virtual or human) of the online identification service 634 executing on the verification server 633.

The user 624, through communication connection 630 between the user device 622 (via the user service application) and the verification server 633 (via the online identification service 634), appears (e.g., as an image, video, voice, or the like) to an identification verifier of the online identification service 634. The user 624, through communication connection 632 between the user device 622 (via the user service application) and the verification server 633 (via the online identification service 634), digitally signs an authorized transaction proving that the user 624 owns the user identifier 626. The user 624, through the communication connection 632, further transmits the user's photo identification 628 to the identification verifier of the online identification service 634. The identification verifier of the online identification service 634 verifies that the user's transmitted photo identification 628 received via communications connection 632 is valid and matches the user appearance received through the communication connection 630. The identification verifier, through communication connection 636 between the verification server 633 (via online identification service 634) and the blockchain 638, records the photo identification 628 (or hash of the photo identification 628) associated to the unique user identifier 626 in the blockchain. The photo identification 628 (or hash of the photo identification 628) may be recorded to the blockchain 238 encrypted or unencrypted, based on preferences configured by the user or the identification user.

### Trust Score

FIG. 9 illustrates a diagram of a trust score calculator 700 that computes a trust score for debt or credit transactions of a user based on one or more configured factors. Preferably, the trust score is calculated based on one or more of tests/factors 702 associated with corresponding assigned weighting, such as the date of the transactions (e.g., on a Monday) 720, as well as a range of additional transaction factors, such as the relationship of the users performing the transaction 712, 713, the currency of the transaction (e.g., rupees 717 or yen 718), whether the transaction was encrypted 719, and the amount of the transaction (e.g., under $100 k) 714.

Weighting tables may be used in embodiments of the computation of a trust score. The trusting score engine may be provided a subset (state) 706 of the factors to use in determining the trust scope for a particular application. Each of the selected factors is assigned a weight 704 based on their ordering in the subset specific to the particular application. A trust scoring engine executing on the application determines whether the selected factors (e.g., transaction with public entity, transaction before 8pm, transaction in yen, and transaction under $100 k) is relevant to a debt or credit transaction, and if relevant, the factor is included in the aggregated total. In some embodiments, instead of assigning ordering of facts by the application, the trust scoring engine may look to the factor with the highest weighting assigned to it, and automatically designate it as the “first factor”, while the factor with the next associated highest weighting is automatically designated as the “second factor.”

Unitless weighting factors 712 are provided, which may also include, for example, continuity factors, such as the date of the transaction (e.g. on a Monday 720) or time of the transaction (e.g., before noon 715 or after Bpm 716). For example, if a transaction for $100 million occurs at 3am on a globally recognized holiday, this suggests that the transaction may be less trusted (e.g., more likely a fraudulent transaction). Application weightings may be assigned that signify the importance of the respective factors in relation to the overall trust score computation. In this way, while some trust score factors involved in the computation may be of greater significance (e.g., amount of the transaction), additional external tests are also preferably considered in the trust score computation. For example, tests/factors beyond the environment of the credit protocol application are considered, such as tests by other service providers (e.g., banks, universities, doctors, and such), security applications executing on a user's device, etc.

### Trust Scoring Analytics

Information related to debt and credit transaction verification test/factors used in the calculation of a trust score, including information regarding which tests/factors are successfully applied versus those that were processed but were not successfully applied can be used to improve the quality of the trust scoring engine. For example, an analytics tool (such as a web analytics tool or business intelligence tool) may produce various metrics, such as measures of user transaction data verification factors/test success and measures of other recorded user data in smart contract on a blockchain node based on the combination of criteria (e.g. environment variables associated with the user), and filter these results by time of the day or time period or location. Such measures can be viewed per test/factor to help improve the trust scoring engine/agent/tool because the results may be aggregated across a multitude of devices, users, and third party service providers.

An analytics tool offers the possibility of associating other quantitative data beside frequency data with a successful test/factor application. For instance, the results of a high trust score calculation could be compared against the metrics derived by an analytics system (such as a web analytics solution or a business intelligence solution).

Furthermore, analytics data for a calculated trust score from a device can be aggregated per type of user (e.g., person or entity) and type of transaction (e.g., financial, health, and such). For example, it could be of interest to know which types of tests/factors are most or least conducive to a high trust score calculation, or on the contrary, applied to a low trust score calculation.

### Merchant Rewards

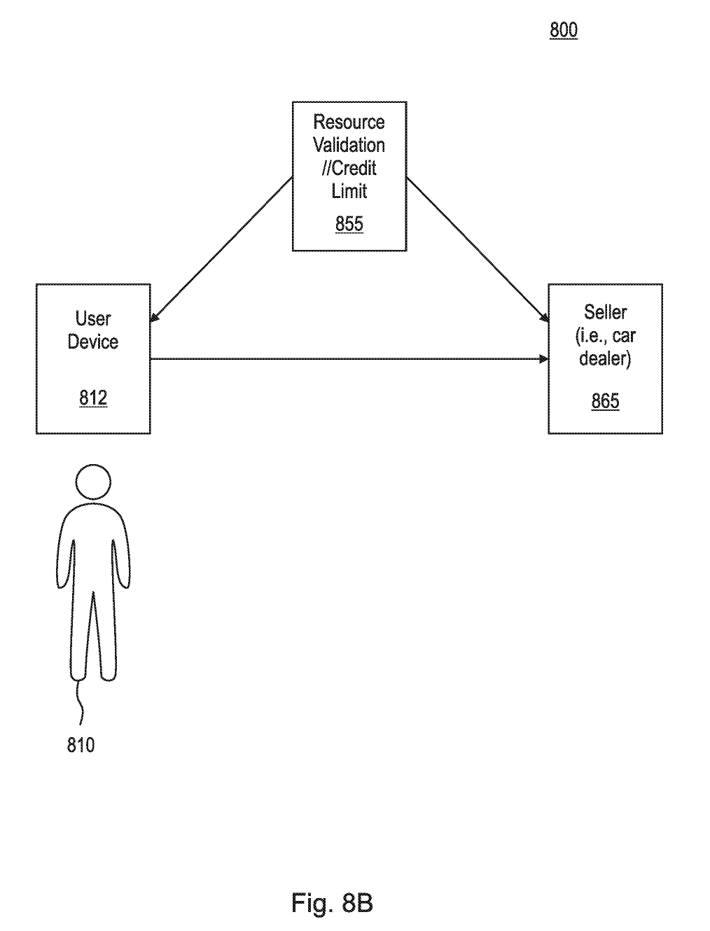

FIGS. 8A-8B are block diagrams of a method/system 800 of accruing and recording credit points for user transactions in example embodiments of the present invention. The credit points method/system 800 of FIG. 8A creates for a user 810 (using user device 812) one or more accounts associated to one or more merchants 820, 825, 830. The credit points method/system 800 stores the one or more accounts in the blockchain or in other memory communicatively coupled to the credit protocol application 233 and associated to a user identifier of the user 810. As the user 810, via user device 812, engage in transactions (e.g., debt and credit transactions described with respect to FIGS. 3, 4, and 5A-C) with other users, a third party points issuer 805, through the credit protocol application 332, accrues points 815 for the user 810 in relation to the one or more merchants 820, 825, 830 and stores the accrued points 815 to the one or more associated accounts created for the user 810. The accrued points 815 are a form of credit between the user 810 and each of the one or more merchants 820, 825, 830. The currency (cryptocurrency, fiat currency, and such) of the credit by a particular merchant is defined by that particular merchant and the merchant defines how much of the currency the user 810 receives from that merchant for a particular transaction. The currency may be accrued toward a reward and may act like a credit card, hotel, airline, or other loyalty program that centers on one form of payment or one user across multiple merchants.

As shown in FIG. 8B, the system/method 800 provides a resource validation application 855. A merchant (e.g., seller) 865 may communicate through the resource validation application 855 (or smart contract executing on a blockchain node) to validate the accrued points 815 (credit limit) that the user 810 accrued in the user's account associated to merchant (seller) 865. The merchant 865 may then credit the user 810 a particular point amount toward a purchase based on the accrued points 815 of the user 810 in an account associated to merchant 865. The merchant 865 may further communicate with the resource validation application 855 to deduce the point amount used toward the purchase in the user's account.

For example, as a user 810 purchases coffee at a cafe (e.g., coffee shop 830) via a user device 812, those purchases may be transmitted to the third party points issuer 805, which in turn transmits the purchases for confirmation to the café 830. Once validated, the third party points issuer 805 may calculate and transmit points based on each purchase (as defined by the cafe 830) to the credit protocol application 332, which may record those purchase points in the distributed blockchain ledger network 200 (in an account for the user 810). The cafe 830 may communicate through the resource validation application 855, coupled to the credit protocol application 233, to validate the accrued points 815 that the user 810 accrued in the user's account for the café 830. The cafe 830 may then credit the user 810 a particular point amount toward a purchase based on the accrued points 815 and further communicate with the resource validation application 810 to deduce the point amount in the user's cafe account.

In other embodiments, the third party points issuer 805, through the credit protocol application 332, may track the user's accrued points 815 for the cafe, and upon reaching a predetermined number of coffee purchases, the credit protocol application 332 may issue the user a predetermined reward, such as a voucher for a free coffee to be redeemed in the café 830.

The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed by the appended claims.

1. A computer-implemented method of executing debt and credit transactions, the method comprises:
registering a first user with a credit protocol application communicatively coupled to a blockchain, the registering includes providing a first user identifier recorded in the blockchain, the first user identifier being associated with a plurality of addresses corresponding to a plurality of computing devices of the first user, wherein prior to association, each of the plurality of addresses associated with the first user identifier is cryptographically authenticated as belonging to a computing device of the first user;
registering a second user with the credit protocol application, the registering includes providing a second user identifier recorded in the blockchain, the second user identifier being associated with a plurality of addresses corresponding to a plurality of computing devices of the second user, wherein prior to association, each of the plurality of addresses associated with the second user identifier is cryptographically authenticated as belonging to a computing device of the second user;
establishing, via the credit protocol application, a secure relationship between a first computing device of the first user and a second computing device of the second user, the establishing includes authenticating the relationship by querying the blockchain to validate that: (i) an address of the first computing device is included in the plurality of addresses securely associated with the first user identifier, and (ii) an address of the second computing device is included in the plurality of addresses securely associated with the second user identifier; and
based on the established relationship:
sending, by the first user from the first computing device to the second user at the second computing device, a request for a debt or credit transaction;
receiving, by the second user at the second computing device, the request, and confirming, by the second user at the second computing device, the debt or credit transaction; and
recording the established relationship, including the confirmed debt or credit transaction, in the blockchain associated to the first and second user identifiers.

2. The method of claim 1, further comprising:
sending, by the second user from the second computing device to the first user at the first computing device, a verification of at least one payment transaction associated to the confirmed debt or credit transaction;
receiving, by the first user at the first computing device, the verification, and confirming by the first user, by the first user at the first computing device, the at least one payment transaction; and
recording the confirmed at least one payment transaction in the blockchain associated to the confirmed debt or credit transaction.

3. The method of claim 1, further comprising:
configuring parameters to validate debt and credit transactions;
comparing, by the credit protocol application, the validation parameters to data related to (i) the debt or credit transaction and (ii) the first and second user identifiers; and
recording the debt or credit transaction, only if the related data meets the validation parameters.

4. The method of claim 3, wherein the validation parameters are defined by one or more smart contracts coupled to the credit protocol application, and the credit protocol application executes the one or more smart contracts to compare the validation parameters to the data related to the debt or credit transaction.

5. The method of claim 4, further comprising:
acquiring, by the first user identifier, at least one token from a smart contract coupled to the credit protocol application, each token enables the first user identifier to participate in a given number of debt and credit transactions per period of time; and
validating, by the credit protocol application executing the smart contract, possession of the acquired at least one token prior to enabling the first user to send the debt or credit transaction.

6. The method of claim 4, wherein the validation parameters used to validate the debt or credit transaction include at least one of: debt or credit type, debt or credit amount, date of transaction, time of transaction, user identifier, relationship between users, currency of transaction, and frequency of transactions over time by a user or between users.

7. The method of claim 1, wherein the debt or credit transaction is recorded in the blockchain encrypted, and the credit protocol application is configured to decrypt the debt or credit transactions for processing.

8. The method of claim 1, wherein each user identifier is a text identifier associated with one or more public keys recorded in the blockchain for the respective user.

9. The method of claim 8, establishing the relationship further comprising:
generating the first user identifier by relating addresses of different computing devices of the first user, each address associated with a public key recorded in the blockchain for the first user;
generating the second user identifier by relating addresses of different computing devices of the second user, each address associated with a public key recorded in the blockchain for the second user; and
establishing the relationship between the second computing device of the second user and the first computing device of the first user by validating that (i) the address of the first computing device is one of the related addresses of the generated first user identifier, and (ii) the address of the second computing device is one of the related addresses of the generated second user identifier.

10. The method of claim 1, wherein each user is an entity or a person.

11. The method of claim 1, wherein registering with the credit protocol application comprises:
signing, by the first user, a transaction indicating ownership of the first user identifier that comprises a public key of a key pair, the signing using a private key of the key pair.

12. The method of claim 1, wherein computing a trust score of debt or credit transactions based on factors used in validating the debt or credit transaction.

13. The method of claim 1, wherein registering the first and second users with a credit protocol application further comprises:
for each of the first and second user:
attesting, via an identification validator, identity of the user; and
determining that the provided user identifier of the user is a single, unique identifier associated exclusively to the user for use in the credit protocol application.

14. The method of claim 13, wherein the user identifier is recorded in the blockchain permanently associated to the identity of the user.

15. The method of claim 13, wherein the attesting to the identity of the user comprises:
performing, via the credit protocol application, biometric validation on the user;
if the biometric validation confirms the identity of the user:
recording in the blockchain, by the identification validator, the user identifier; and
recording in the blockchain, by the identification validator, the user identity associated to the recorded first user identifier.

16. The method of claim 15, wherein attesting to the identity of the user further comprises:
determining, by an identification validator, whether user identification presented by the first user matches physical characteristics of the first user; and
if the presented identification and the physical characteristics match:
signing, by the first user, a transaction indicating ownership of the first user identifier that comprises a public key of a key pair, the signing using a private key of the key pair;
recording in the blockchain, by the identification validator, the first user identifier; and
recording in the blockchain, by the identification validator, the presented user identification associated to the recorded first user identifier.

17. The method of claim 13, wherein the attested identity of the user includes at least one of: date of birth of the user, photo identification of the user, voice identification of the user, current assets of the user, and credit history of the user.

18. The method of claim 13, wherein providing a credit scoring application that, based on a generated user identifier, enables creditors to prove a debtor associated to the generated user identifier does not have undisclosed credit or debt and to compare complete financial resources of the debtor.

19. The method of claim 14, wherein using the user identifier to provide a merchant points application that accrues and records user credit points from transactions by the user with one or multiple merchants.

20. The method of claim 1, wherein recording, by the first user via the credit protocol application, pending debt or credit to a centralized holding place, including at least one of a server, computer memory coupled to the credit protocol application, and the blockchain, rather than sending the debt or credit transaction to the second user.

21. A computer system for executing debt and credit transactions, the system comprises:
a first computing device coupled to a first user, the first computing device having a first address; and a second computing device coupled to a second user, the second computing device having a second address;
a credit protocol processor implementing a credit protocol application, the credit protocol processor communicatively coupled to the blockchain, the credit protocol processor configured to:
register a first user with a credit protocol application communicatively coupled to a blockchain, the registering includes providing a first user identifier recorded in the blockchain, the first user identifier being associated with a plurality of addresses corresponding to a plurality of computing devices of the first user, wherein prior to association, each of the plurality of addresses associated with the first user identifier is cryptographically authenticated as belonging to a computing device of the first user;
register a second user with the credit protocol application, the registering includes providing a second user identifier recorded in the blockchain, the second user identifier being associated with a plurality of addresses corresponding to a plurality of computing devices of the second user, wherein prior to association, each of the plurality of addresses associated with the second user identifier is cryptographically authenticated as belonging to a computing device of the second user;
establish, via the credit protocol application, a secure relationship between a first computing device of the first user and a second computing device of the second user, the establishing includes authenticating the relationship by querying the blockchain to validate that: (i) an address of the first computing device is included in the plurality of addresses securely associated with the first user identifier, and (ii) an address of the second computing device is included in the plurality of addresses securely associated with the second user identifier; and
based on the established relationship:
the first computing device configured to send, from the first user to the second user at the second computing device, a request for a debt or credit transaction;
the second computing device configured to receive the request, and confirm, in response to input from the second user, the debt or credit transaction; and
the credit protocol processor further configured to record established relationship, including the the confirmed debt or credit transaction in the blockchain associated to the first and second user identifiers.

22. The system of claim 21, further comprising:
the second computing device further configured to send, from the second user to the first user at the first computing device, a verification of at least one payment transaction associated to the confirmed debt or credit transaction;
the first computing device further configured to receive the verification, and confirm, in response to input from the first user, the at least one payment transaction; and
the credit protocol processor further configured to record the confirmed at least one payment transaction in the blockchain associated to the confirmed debt or credit transaction.

23. The system of claim 21, wherein the credit protocol processor is further configured to:
configure parameters to validate debt and credit transactions;
compare, by the credit protocol application, the validation parameters to data related to (i) the debt or credit transaction and (ii) the first and second user identifiers; and
record the debt or credit transaction, only if the related data meets the validation parameters.

24. The system of claim 23, wherein the validation parameters are defined by one or more smart contracts coupled to the credit protocol application, and the credit protocol application executes the one or more smart contracts to compare the validation parameters to the data related to the debt or credit transaction.

25. The system of claim 24, wherein the credit protocol processor is further configured to:
acquire, in relation to the first user identifier, at least one token from a smart contract coupled to the credit protocol application, each token enables the first user identifier to participate in a given number of debt and credit transactions per time period; and
validate, by the credit protocol application executing the smart contract, possession of the acquired at least one token prior to enabling the first user to send the debt or credit transaction.

26. The system of claim 24, wherein the validation parameters used to validate the debt or credit transaction include at least one of: debt or credit type, debt or credit amount, date of transaction, time of transaction, user identifier, relationship between users, currency of transaction, and frequency of transactions by a user or between users.

27. The system of claim 21, wherein the credit protocol processor is further configured to record, via the credit protocol application, the debt or credit transaction in the blockchain encrypted, and the credit protocol application is configured to decrypt the debt or credit transactions for processing.

28. The system of claim 21, wherein each user identifier is a text identifier associated with one or more public keys recorded in the blockchain for the respective user.

29. The system of claim 28, wherein the credit protocol processor is further configured to establish the relationship by:
generating the first user identifier by relating addresses of different computing devices of the first user, each address associated with a public key recorded in the blockchain for the first user;
generating the second user identifier by relating addresses of different computing devices of the second user, each address associated with a public key recorded in the blockchain for the second user; and
establishing the relationship between the second computing device of the second user and the first computing device of the first user by validating that (i) the address of the first computing device is one of the related addresses of the generated first user identifier, and (ii) the address of the second computing device is one of the related addresses of the generated second user identifier.

30. The system of claim 21, wherein each user is an entity or a person.

31. The system of claim 21, wherein the credit protocol processor registers a user with the credit protocol application by:
signing, by the first user via the first computing device, a transaction indicating ownership of the first user identifier that comprises a public key of a key pair, the signing using a private key of the key pair.

32. The system of claim 21, wherein the credit protocol processor is further configured to compute a trust score of debt or credit transactions based on factors used in validating the debt or credit transaction.

33. The system of claim 21, wherein the credit protocol processor is configured to register the first and second users with the credit protocol application by:
for each of the first and second user:
attesting, via an identification validator, identity of the user; and
determining that the provided user identifier of the user is a single, unique identifier associated exclusively to the user for use in the credit protocol application.

34. The system of claim 33, wherein the credit protocol processor is further configured to record the user identifier in the blockchain permanently associated to the identity of the user.

35. The system of claim 33, wherein the credit protocol processor is further configured to attest to the identity of the user by:
performing, via the credit protocol application, biometric validation on the user; if the biometric validation confirms the identity of the user:
recording in the blockchain, by the identification validator, the user identifier; and
recording in the blockchain, by the identification validator, the user identity associated to the recorded first user identifier.

36. The system of claim 35, wherein the credit protocol processor is further configured to attest to the identity of the user by:
determining, by an identification validator, whether user identification presented by the first user matches physical characteristics of the first user; and
if the presented identification and the physical characteristics match:
signing, by the first user, a transaction indicating ownership of the first user identifier that comprises a public key of a key pair, the signing using a private key of the key pair;
recording in the blockchain, by the identification validator, the first user identifier; and
recording in the blockchain, by the identification validator, the presented user identification associated to the recorded first user identifier.

37. The system of claim 33, wherein the attested identity of the user includes at least one of: date of birth of the user, photo identification of the user, voice identification of the user, current assets of the user, and credit history of the user.

38. The system of claim 33, wherein the credit protocol processor further implements a credit scoring application configured to, based on a generated user identifier, enable creditors to prove a debtor associated to the generated user identifier does not have undisclosed credit or debt and compare complete financial resources of the debtor.

39. The system of claim 33, wherein the credit protocol processor is further configured to use the user identifier to provide a merchant points application that accrues and records user credit points from transactions by the user with one or multiple merchants.

40. The system of claim 21, wherein the credit protocol processor is configured to record, by the first user, pending debt or credit to a centralized holding place, including at least one of a server, computer memory coupled to the credit protocol processor, and the blockchain, rather than sending the debt or credit transaction to the second user.

41. A computer program product comprising:
a non-transitory computer-readable storage medium having code instructions stored thereon, the storage medium operatively coupled to a processor such that, when executed by the processor, the computer code instructions cause the processor to:
register a first user with a credit protocol application communicatively coupled to a blockchain, the registering includes providing a first user identifier recorded in the blockchain, the first user identifier being associated with a plurality of addresses corresponding to a plurality of computing devices of the first user, wherein prior to association, each of the plurality of addresses associated with the first user identifier is cryptographically authenticated as belonging to a computing device of the first user;
register a second user with the credit protocol application, the registering includes providing a second user identifier recorded in the blockchain, the second user identifier being associated with a plurality of addresses corresponding to a plurality of computing devices of the second user, wherein prior to association, each of the plurality of addresses associated with the second user identifier is cryptographically authenticated as belonging to a computing device of the second user;
establish, via the credit protocol application, a secure relationship between a first computing device of the first user and a second computing device of the second user, the establishing includes authenticating the relationship by querying the blockchain to validate that: (i) an address of the first computing device is included in the plurality of addresses securely associated with the first user identifier, and (ii) an address of the second computing device is included in the plurality of addresses securely associated with the second user identifier; and
based on the established relationship:
send, by the first user from the first computing device to the second user at the second computing device, a request for a debt or credit transaction;
receive, by the second user at the second computing device, the request, and confirm, by the second user at the second computing device, the debt or credit transaction; and
record the established relationship, including the confirmed debt or credit transaction in the blockchain associated to the first and second user identifiers.
